(19) United States
(12) Patent Application Publication
(10) Pub. No.: US 2003/0056772 A1
(43) Pub. Date: Mar. 27, 2003

(54) Method and system for regulating the air charge temperature in engines having an intercooler

(76) Inventors: Dirk Borrmann, Huerth (DE); Franz-Josef Schneider, Bergheim (DE); Klemens Grieser, Langenfeld (DE); Michael Tobergte, Koeln (DE)

Correspondence Address: FORD GLOBAL TECHNOLOGIES, INC, SUITE 600 - PARKLANE TOWERS EAST, ONE PARKLANE BLVD., DEARBORN, MI, 48126, US

(21) Appl. No.: 10/185,482

(22) Filed: Jul. 1, 2002

(30) Foreign Application Priority Data
Jun. 29, 2001 (EP) 01115872.2

(51) Int. Cl. F02B 33/00

(52) U.S. Cl. 123/563; 60/599

(57) ABSTRACT

The invention relates to a method for cooling the charge air of an internal combustion engine. The charge-air cooler is arranged with a pump and a heat exchanger in a coolant circuit. The temperature of the charge air is detected via a temperature sensor and passed on to a regulating unit. As a function of this temperature and, if appropriate, of further engine operating parameters, the regulating unit controls the pump and, if included, the fan of the heat exchanger. Thus, in particular, when the engine is started cold or at a partial load, a higher charge-air temperature can be permitted by switching off or throttle the pump and/or the fan. This not only better matches the charge-air temperature to the engine operation, but also saves on energy for the operation of the pump and/or the fan.

### FIELD OF THE INVENTION

The field of the invention relates generally to intercoolers for internal combustion engines.

### BACKGROUND OF THE INVENTION

To increase the power of internal combustion engines, it is known to compress the air charge which is fed to the engine before it is mixed with the fuel. However the heating occurring during this compression of the air charge is normally undesirable. Therefore, the temperature is lowered to a desired level within an intercooler. In such systems, the intercooler is generally integrated in a cooling-water circuit, the cooling water being continuously recirculated by an electric pump. Typically, heat is transferred away from the recirculated cooling water by a heat exchanger which is cooled by ambient air. One disadvantage of these known methods is that the cooling-water pump is in continuous operation, which involves a corresponding consumption of electrical current. Furthermore, it has been shown that cooling the air charge is not optimal for every operating state of the engine.

Previous systems, as described in U.S. Pat. No. 5,632,256, U.S. Pat. No. 5,669,363, WO 92/01445 and EP 0 708 231, conduct the air charge past the intercooler via a regulatable bypass and directly into the engine. However, a disadvantage of this arrangement is that the power input for the cooling mechanism for the air charge remains undiminished.

Another system, described in U.S. Pat. No. 5,201,285, places the intercooler in a bypass flow of the coolant circuit of the internal combustion engine. In this arrangement, the temperature of the air charge is measured, and as a function of this measurement, a greater or lesser amount of coolant is conducted through the intercooler. Furthermore, the speed of a heat exchanger fan is controlled as a function of the ambient air. This system is disadvantageous in that the cooling of the internal combustion engine is not independent of the air charge cooling and a relatively large power input is required.

### SUMMARY OF THE INVENTION

Disadvantages of prior art approaches are overcome by a method for regulating a temperature of air charge delivered to an internal combustion engine. The engine has an intercooler through which the air charge passes and a separate air charge coolant circuit having a heat exchanger, a coolant pump and preferably a fan for directing ambient air across the heat exchanger. The temperature of the air charge is determined and based on this temperature, the coolant pump and/or the fan is controlled. The pump and fan is adjusted by controlling the power delivered to them or by turning them off.

A system for regulating a temperature of air charge inducted into an internal combustion engine is also disclosed which includes: an air charge coolant circuit having an intercooler through which the air charge travels, a coolant pump, and a heat exchanger. The system further includes a temperature sensor arranged in the flow path of the air charge located downstream of the intercooler and a controller coupled to the temperature sensor and the coolant pump.

A primary advantage of the present invention is a savings in the electrical current provided to the coolant pump and the fan. Electrical energy savings provide a fuel economy improvement to the vehicle.

An advantage of the present invention is that it provides more appropriate matching of the air charge temperature to the engine operating state.

Furthermore, because both the fan and the water pump are regulated, finer control of the air charge temperature is another advantage provided by the present invention.

An additional advantage of this system is that by controlling either the cooling pump or the fan better control over the air charge temperature may be achieved.

The above advantages, other advantages, and other features of the present invention will be readily apparent from the following detailed description of the preferred embodiments when taken in connection with the accompanying drawings.

### BRIEF DESCRIPTION OF THE DRAWINGS

The advantages described herein will be more fully understood by reading an example of an embodiment in which the invention is used to advantage, referred to herein as the Detailed Description, with reference to the drawing wherein:

FIG. 1 is a schematic of the air charge coolant system.

### DETAILED DESCRIPTION

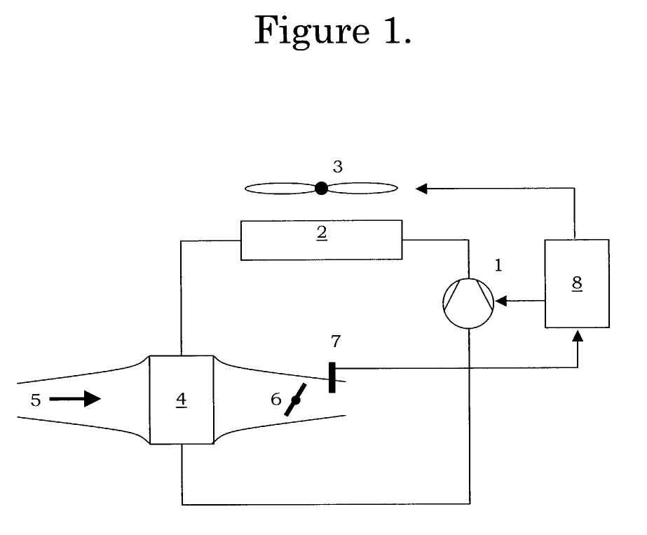

Referring to FIG. 1, the compressed air charge 5 which is provided for the combustion process in an internal combustion engine (not shown) passes through an intercooler 4 in the direction indicated by the arrow to reduce the temperature increase caused by the compression of the air charge 5 in intercooler 4. On the output side of intercooler 4, a throttle valve 6 is situated in the air charge flow and can be used to influence the magnitude of this flow. A temperature sensor 7, for detecting the temperature of the air charge, is also situated so as to be capable of measuring the air charge. Temperature sensor 7 is a thermocouple, thermistor or any other temperature sensing device.

In intercooler 4, heat is transferred from air charge 5 to a coolant, such as water. The coolant is recirculated in a separate coolant circuit in which intercooler 4, a pump 1, and a heat exchanger 2 are disposed, which is independent of the engine cooling system. In heat exchanger 2, the heat transferred to the coolant is transferred into the ambient air. Heat exchanger 2 can additionally have ambient air directed toward it by a fan 3 to obtain an increased heat transfer rate.

In prior art air charge cooling arrangements, water pump 1 is operated at a constant level and maximum cooling of the air charge 5 takes place continuously. The inventors herein propose using a regulating unit 8. Regulating unit 8 is connected to temperature sensor 7 to obtain from the latter a signal indicating the air charge temperature. Alternatively, regulating unit 8 has further sensory inputs or data inputs (not illustrated) to detect other operating parameters of the internal combustion engine.

On the output side, regulating unit 8 is connected to water pump 1 and to fan 3. Through these outputs, regulating unit 8 varies the power to water pump 1, the power to fan 3, or completely shuts down these elements. If regulating unit 8 establishes, for example, that the air charge temperature is already at a desired (low) level, it saves current by decreasing power to pump 1 or fan 3 while ensuring that the air charge temperature does not increase above the desired level.

Furthermore, regulating unit 8 can ensure that the air charge temperature is optimally matched to the present operating condition of the internal combustion engine. In particular, after starting the engine and while the engine is heating up, the air charge temperature can be regulated to a comparatively high value to assist with the rapid heating of the internal combustion engine. If appropriate, heating devices may also be provided for this purpose, for example in the cooling circuit, so that contrary to normal operation, an increase in the temperature of air charge 5 can take place in intercooler 4.

The desired air charge temperature depends on the engine operating condition. For example, at a partial torque of the internal combustion engine, it is advantageous to have a relatively high air charge temperature to improve the utilization of fuel, for example to better vaporize the fuel. In contrast, at a high load or at high ambient temperatures, it is desirable to have low air charge temperature to optimize the density of the air charge and, hence, power output of the engine.

While several modes for carrying out the invention have been described in detail, those familiar with the art to which this invention relates will recognize alternative designs and embodiments for practicing the invention. The above-described embodiments are intended to be illustrative of the invention, which may be modified within the scope of the following claims.

What is claimed is:

1. A method for regulating a temperature of air charge delivered to an internal combustion engine, the engine having an intercooler through which the air charge passes and an air charge coolant circuit having a heat exchanger and a coolant pump, comprising:
determining the temperature of the air charge; and,
controlling the coolant pump based on the temperature of the air charge.

2. The method of claim 1 wherein the coolant pump is controlled as a function of further operating parameters of the internal combustion engine.

3. The method of claim 1 wherein said control of the coolant pump comprises switching off the coolant pump.

4. The method of claim 1 wherein said control of the coolant pump comprises varying power to the coolant pump.

5. The method of claim 1 wherein said control occurs after starting the engine and at lower than average engine torque.

6. The method of claim 1 wherein the cooling circuit further comprises a fan to direct ambient air towards the heat exchanger, further comprising the step of controlling the fan based on the temperature of the air charge.

7. The method of claim 6 wherein said control of the fan comprises switching off the fan.

8. A system for regulating a temperature of air charge inducted into an internal combustion engine, comprising:
an air charge coolant circuit having an intercooler, a coolant pump, and a heat exchanger wherein the air charge is conducted through said intercooler;
a temperature sensor arranged in the flow path of the air charge located downstream of said intercooler; and
a controller coupled to said temperature sensor and said coolant pump.

9. The system of claim 8, further comprising a fan for directing ambient air to the heat exchanger to cool the heat exchanger.

10. The system of claim 8 wherein said controller adjusts an electrical current to said coolant pump.

11. The system of claim 10 wherein said adjustment is based on a signal from said temperature sensor.

12. The system of claim 9 wherein said controller adjusts an electrical current to said fan.

13. The system of claim 12 wherein said adjust is based on a signal from said temperature sensor.

14. The system of claim 8, further comprising a valve disposed in said air charge cooling circuit, said valve being coupled to said controller, a position of said valve being controlled by said controller based on a signal from said temperature sensor.
